(19) United States
(12) Patent Application Publication
(10) Pub. No.: US 2022/0407794 A1
(43) Pub. Date: Dec. 22, 2022

(54) TRANSMISSION CONTROL DEVICE, TRANSMISSION CONTROL METHOD, AND TRANSMISSION CONTROL PROGRAM

(71) Applicant: Nippon Telegraph and Telephone Corporation, Tokyo (JP)

(72) Inventors: Hiroshi OSAWA, Musashino-shi, Tokyo (JP); Yuhei HAYASHI, Musashino-shi, Tokyo (JP); Chiharu MORIOKA, Musashino-shi, Tokyo (JP); Hiroki INOUE, Musashino-shi, Tokyo (JP); Takeaki NISHIOKA, Musashino-shi, Tokyo (JP); Yuki MIYOSHI, Musashino-shi, Tokyo (JP)

(21) Appl. No.: 17/773,430

(22) PCT Filed: Oct. 30, 2019
(86) PCT No.: PCT/JP2019/042693

§ 371 Date: Apr. 29, 2022

(51) Int. Cl. H04L 43/0894; H04L 43/026

(52) U.S. Cl. CPC H04L 43/0894; H04L 43/026

(57) ABSTRACT

When receiving packets of a flow from a network device (1), a transmission control device (10) determines, according to processing abilities of flow collectors (20), rates in transmitting information concerning the flow to the collectors 20. The transmission control device (10) selects, based on header information of the received packets, the flow collector (20) to be a transmission destination of the information concerning the flow of the packets. The transmission control device (10) transmits the information concerning the flow at the rate determined for each of the flow collectors (20).

### TECHNICAL FIELD

The present invention relates to a transmission control device, a transmission control method, and a transmission control program.

### BACKGROUND ART

For monitoring of a network and a tendency analysis of traffic, there is a technique in which a network device performs sampling of packets of a target flow, creates statistical information and the like of the flow from header information of the sampled packets, and transmits the statistical information and the like to a flow collector (hereinafter abbreviated as collector as appropriate) or transmits a header portion itself of the sampled packet to the collector. The collector performs a tendency analysis and the like of traffic of the flow based on information concerning the flow received from the network device.

### CITATION LIST

### Non-Patent Literature

Non-Patent Literature 1: NetFlow (RFC3954), [searched on Oct. 16, 2019], Internet <URL: https://www.ietf.org/rfc/rfc3954.txt>
Non-Patent Literature 2: IPFIX (RFC5103), [searched on Oct. 16, 2019], Internet <URL:https://www.ietf.org/rfc/rfc5103.txt>
Non-Patent Literature 3: sFlow, [searched on Oct. 16, 2019], Internet <URL:https://sflow.org/sflow_version_5.txt>
Non-Patent Literature 4: Information Elements for Data Link Layer Traffic Measurement (RFC7133), [searched on Oct. 16, 2019], Internet <URL:https://tools.ietf.org/html/rfc7133>
Non-Patent Literature 5: pmacct, [searched on Oct. 16, 2019], Internet <URL:http://www.pmacct.net/>
Non-Patent Literature 6: nProbe, [searched on Oct. 16, 2019], Internet <https://www.ntop.org/products/netflow/nprobe/>

### SUMMARY OF THE INVENTION

### Technical Problem

In some case, collectors including different analyzing functions are prepared and the collectors respectively perform tendency analyses of traffic, DDoS (Distributed Denial of Service attack) detection, and the like. In such a case, a processing ability of an analysis is different or an information amount necessary for the analysis is different for each of the collectors. Accordingly, for example, when the network device transmits the information concerning the flow described above to a plurality of collectors by broadcast, it is likely that, in some collectors, the information concerning the flow overflows and processing abilities of the collectors are deteriorated or analysis accuracy and detection accuracy of the collectors are deteriorated because the information concerning the flow is insufficient.

When the processing abilities of the collectors are insufficient, it is conceivable that the number of collectors including the same functions is increased and network devices transmit the information concerning the flow to different collectors. However, the method has low efficiency because the collectors redundantly have information concerning the same flow. The method has a problem in that analysis accuracy of the flow is deteriorated when the collectors perform analyses of the flow because the information concerning the flow is dispersed to the collectors.

Therefore, an object of the present invention is to solve the problems described above, improve efficiency at the time when the collectors perform the analyses of the flow, and to prevent deterioration in the analysis accuracy.

### Means for Solving the Problem

In order solve the problems described above, the present invention includes: a receiving unit configured to receive packets of a flow from a network device; a storing unit configured to store information concerning one or more flow collectors to be transmission destinations of information concerning the flow of the received packets; a rate determining unit configured to determine, according to processing abilities of the flow collectors, rates in transmitting the information concerning the flow to the flow collectors; a selecting unit configured to select, based on header information of the received packets, a flow collector to be a transmission destination of the information concerning the flow of the packets; and a transmission processing unit configured to transmit, at the rate determined for each of the flow collectors, the information concerning the flow to the flow collector.

### Effects of the Invention

According to the present invention, it is possible to improve efficiency at the time when the collectors perform analyses of the flow and to prevent deterioration in analysis accuracy.

### BRIEF DESCRIPTION OF DRAWINGS

FIG. 1 is a diagram for explaining an operation example of a system including a transmission control device.

FIG. 2 is a diagram showing a configuration example of the transmission control device.

FIG. 3 is a flowchart showing an example of a processing procedure of the transmission control device shown in FIG. 2.

FIG. 4 is a diagram for explaining an example of a rate adjusting method in the transmission control device shown in FIG. 2.

FIG. 5 is a flowchart showing an example of a processing procedure in (1) a method of using relative rates in the rate adjusting method shown in FIG. 4.

FIG. 6 is a flowchart showing an example of a processing procedure in (2) a method of using absolute rates in the rate adjusting method shown in FIG. 4.

FIG. 7 is a flowchart showing an example of a processing procedure in (3) a method of limiting output rates to flow collectors in the rate adjusting method shown in FIG. 4.

FIG. 8 is a diagram for explaining an example of a selection method for a flow collector in the transmission control device shown in FIG. 2.

FIG. 9 is a flowchart showing an example of a processing procedure in (1) the case in which a rearrangement hash is used when the transmission control device shown in FIG. 2 selects the flow collector.

FIG. 10 is a flowchart showing an example of a processing procedure in (2) the case in which an own address hash is used when the transmission control device shown in FIG. 2 selects the flow collector.

FIG. 11 is a diagram showing a configuration example of a computer that executes a transmission control program.

### DESCRIPTION OF EMBODIMENTS

### Operation Example

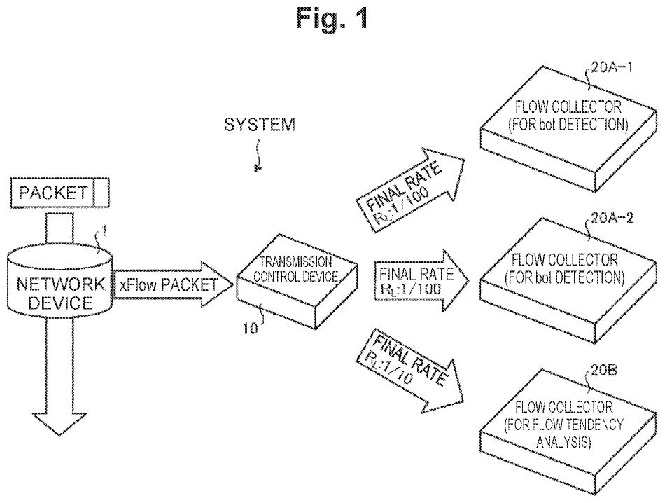

Hereafter, a mode for carrying out the present invention (an embodiment) is explained with reference to the drawings. The present invention is not limited to this embodiment. First, an operation example of a system including a transmission control device 10 in this embodiment is explained with reference to FIG. 1. The numbers of network devices 1, transmission control devices 10, and flow collectors 20 are not limited to the numbers shown in FIG. 1.

Note that, in the following explanation, an xFlow packet treated by the system is a packet of NetFlow, IPFIX, sFlow, or the like.

Information concerning the xFlow packet (xFlow information) transmitted to the flow collectors 20 by the transmission control device 10 is information obtained by changing information concerning the xFlow packet received from the network device 1 to a form processable in the flow collectors 20. Note that the information concerning the xFlow packet may be, for example, statistical information of the xFlow packet received from the network device 1 or may be the xFlow packet itself received from the network device 1.

The system includes, for example, the network device 1, the transmission control device 10, and the flow collectors 20. The network device 1 is, for example, a router and performs sampling of the xFlow packet and transmits the sampled xFlow packet to the transmission control device 10.

The transmission control device 10 generates xFlow information based on the xFlow packet sampled by the network device 1 and transmits the xFlow information to the flow collectors 20. The flow collectors 20 perform analyses of xFlow and various kinds of detection based on the received xFlow information.

In FIG. 1, an example is explained in which the flow collectors 20 at transmission destinations of the xFlow information of the transmission control device 10 are flow collectors 20A (20A-1 and 20A-2) and a flow collector 20B. The flow collectors 20A perform detection of bot from the received xFlow information. The flow collector 20B analyzes a tendency of a flow from the received xFlow information.

In the following explanation, when not particularly distinguished, the flow collectors 20A and 20B are collectively referred to as flow collectors 20. Similarly, two flow collectors 20A-1 and 20A-2 are collectively referred to as flow collectors 20A. It is assumed that the same functions are respectively equipped in the flow collectors 20A-1 and 20A-2.

The transmission control device 10 transmits the xFlow information at rates corresponding to processing abilities of the respective flow collectors 20.

For example, when the processing ability of the flow collectors 20A-1 and 20A-2 is lower compared with the processing ability of the flow collector 20B, the transmission control device 10 sets a rate in transmitting the xFlow information to the flow collectors 20A-1 and 20A-2 lower than a rate in transmitting the xFlow information to the flow collector 20B.

As a specific example, the transmission control device 10 sets a rate (a final rate R_{L}) in transmitting the xFlow information to the flow collector 20B to 1/10 and sets a rate (the final rate R_{L}) in transmitting the xFlow information to the flow collectors 20A-1 and 20A-2 to 1/100. Int this way, it is possible to prevent the xFlow information from overflowing in the flow collectors 20A-1 and 20A-2.

When transmitting the xFlow information to the flow collectors 20A-1 and 20A-2, the transmission control device 10 selects a flow collector at a transmission destination of the xFlow information based on header information of the xFlow packet on which the xFlow information is based.

For example, about xFlow information concerning an xFlow packet having the same combination of a transmission source IP address and a transmission destination IP address as the combination indicated by the header information of the xFlow packet received from the network device 1, the transmission control device 10 sets the flow collectors 20A at transmission destinations of the xFlow information to the same flow collectors 20A.

Consequently, for example, the transmission control device 10 can transmit xFlow information of an xFlow packet of the same flow to the same flow collectors 20A. As a result, it is possible to prevent analysis accuracy of the flow in the flow collectors 20A from being deteriorated.

### Configuration Example

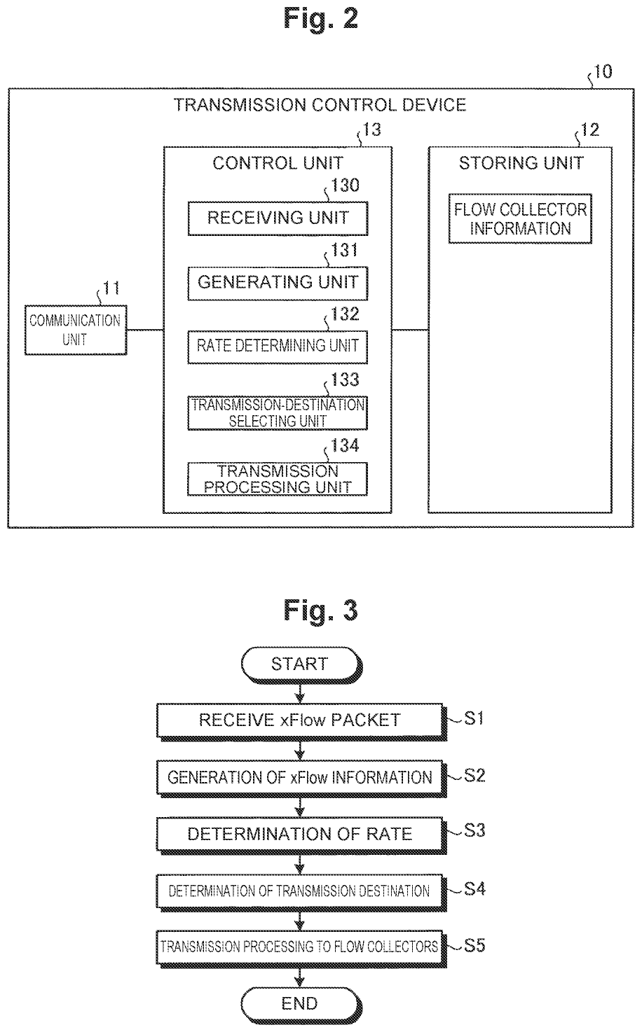

Subsequently, a configuration example of the transmission control device 10 is explained with reference to FIG. 2. The transmission control device 10 includes a communication unit 11, a storing unit 12, and a control unit 13.

The communication unit 11 is realized by, for example, a NIC (Network Interface Card). The communication unit 11 is connected to a network by wire or radio and performs transmission and reception of various data to and from the network device 1 and the flow collectors 20.

The storing unit 12 is realized by a semiconductor memory element such as a RAM (Random Access Memory) or a flash memory or a storage device such as a hard disk or an optical disk.

The storing unit 12 stores information that the control unit 13 refers to when executing various kinds of processing. For example, the storing unit 12 stores flow collector information. The flow collector information is information indicating, for example, processing abilities, functions, and addresses of the respective flow collectors 20 to be transmission destinations of xFlow information.

The control unit 13 manages control of the entire transmission control device 10. The control unit 13 is realized by executing, with, for example, the CPU (Central Processing Unit) or an MPU (Micro Processing Unit), using a RAM as a work area, various programs (equivalent to an example of a transmission control program) stored in a storage device inside the transmission control device 10.

The control unit 13 includes, for example, a receiving unit 130, a generating unit 131, a rate determining unit 132, a transmission-destination selecting unit (a selecting unit) 133, and a transmission processing unit 134.

The receiving unit 130 receives an xFlow packet from the network device 1. The generating unit 131 generates, based on the xFlow packet received by the receiving unit 130, xFlow information of the xFlow packet.

The rate determining unit 132 determines a rate in transmitting the xFlow information generated by the generating unit 131 to the flow collectors 20. Specifically, the rate determining unit 132 determines, according to processing abilities of the respective flow collectors 20, rates in transmitting the xFlow information to the flow collectors 20. Details of the rate determining unit 132 are explained below with reference to a specific example.

The transmission-destination selecting unit 133 selects the flow collectors 20 to be transmission destinations of the xFlow information generated by the generating unit 131.

For example, it is assumed that there is a plurality of flow collectors 20 having the same functions as the flow collectors 20 to be the transmission destinations of the xFlow information. In this case, the transmission-destination selecting unit 133 sets, as any one flow collectors 20 selected out of the flow collectors 20 having the same functions described above, a transmission destination of the xFlow information concerning xFlow packets, for which at least one of transmission source addresses or transmission destination addresses are the same, among the xFlow information generated by the generating unit 131.

For example, it is assumed that there are the flow collector 20A-1 and the flow collector 20A-2 respectively having the same functions as the flow collectors 20 to be the transmission destinations of the xFlow information. In this case, the transmission-destination selecting unit 133 selects one flow collector 20 of the flow collector 20A-1 and the flow collector 20A-2 as a transmission destination of the xFlow information, combinations of transmission source addresses and transmission destination addresses of which are the same. Consequently, for example, bidirectional xFlow information of the same flow respectively reach the same flow collector 20.

The transmission processing unit 134 transmits the xFlow information generated by the generating unit 131 to the flow collectors 20 at the rate determined by the rate determining unit 132. For example, the transmission processing unit 134 transmits the xFlow information at a rate determined for each of the flow collectors 20.

With such a transmission control device 10, it is possible to improve efficiency at the time when the flow collectors 20 perform analyses of a flow and to prevent deterioration in analysis accuracy.

### Example of a Processing Procedure

An example of a processing procedure of the transmission control device 10 is explained with reference to FIG. 3.

The receiving unit 130 of the transmission control device 10 receives an xFlow packet from the network device 1 (S1). The generating unit 131 generates xFlow information of the xFlow packet received in S1 (S2). Thereafter, the rate determining unit 132 determines a rate in transmitting the xFlow information to the flow collectors 20 (S3).

When there is a plurality of flow collectors 20 having the same functions in the flow collectors 20 at transmission destinations of the xFlow information, the transmission-destination selecting unit 133 selects one flow collector 20 out of a group of the flow collectors 20 having the same functions described above as a transmission destination of the xFlow information, at least one of transmission sources and transmission destinations of which are the same (S4: determination of a transmission destination).

The transmission processing unit 134 transmits the xFlow information generated in S2 to the flow collectors 20 at the rate determined in S3 (S5: transmission processing to the flow collectors). Note that, when the transmission-destination selecting unit 133 selects the flow collector 20 at the transmission destination of the xFlow information in S4, the transmission processing unit 134 transmits the xFlow information to the flow collector 20 selected in S4.

In this way, the transmission control device 10 can transmit the xFlow information at rates corresponding to processing abilities of the flow collectors 20. When there is a plurality of flow collectors 20 having the same functions in the flow collectors 20 at the transmission destinations of the xFlow information, the transmission control device 10 can transmit, about the xFlow information, at least one of transmission sources and transmission destinations of which are the same, the xFlow information to the same flow collectors 20. As a result, it is possible to improve efficiency at the time when the flow collectors 20 perform analyses of a flow and to prevent deterioration in analysis accuracy.

### Example of Adjustment of a Rate

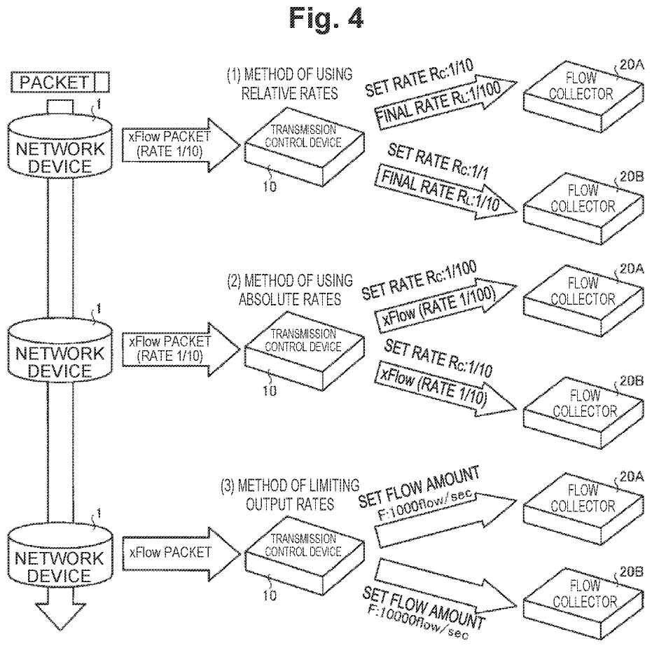

Subsequently, an example of a rate adjusting method in transmitting xFlow information to the flow collectors 20 in the transmission control device 10 is explained with reference to FIG. 4. As the rate adjusting method, there are, for example, (1) a method of using relative rates, (2) a method of using absolute rates, and (3) a method of limiting output rates to flow collectors.

Note that, in the following explanation, an example is explained in which the transmission control device 10 transmits xFlow information to the flow collectors 20A and 20B. It is assumed that a processing ability of the flow collectors 20A is lower than a processing ability of the flow collector 20B.

(1) Method of using relative rates

First, (1) the method of using relative rates is explained. For example, when receiving an xFlow packet sampled at a rate R_{I} from the network device 1, the transmission control device 10 transmits xFlow information of the received xFlow packet to the flow collectors 20 at a set rate R_{C} determined for each of the flow collectors 20.

That is, a final rate R_{L} in the flow collectors 20 is a value indicated by the following Expression (1).

R_{L}=R_{I}×R_{C} Expression(1)

For example, according to the processing abilities of the flow collectors 20, the rate determining unit 132 sets the set rate R_{C} of the flow collector 20B to 1/1 and sets the set rate R_{C} of the flow collectors 20A to 1/10.

The transmission processing unit 134 transmits the xFlow information of the received xFlow packet to the flow collectors 20A at a rate=1/10 according to the set rates R_{C} of the flow collectors 20 described above. The transmission processing unit 134 transmits the xFlow information of the received xFlow packet to the flow collector 20B at a rate=1/1. As a result, the final rate R_{L} of the xFlow information input to the flow collectors 20A is 1/100. The final rate R_{L} of the xFlow information input to the flow collector 20B is 1/10.

In this way, the transmission control device 10 can transmit the xFlow information at the set rates corresponding to the processing abilities of the flow collectors 20.

(2) Method of using absolute rates

Referring back to FIG. 4, (2) the method of using absolute rates is explained. An example is explained in which the transmission control device 10 receives an xFlow packet sampled at the rate R_{I} from the network device 1. Note that information indicating the rate R_{I} described above is given to the sampled xFlow packet.

When receiving an xFlow packet from the network device 1, the transmission control device 10 controls, referring to the information indicating the rate R_{I} described above, rates in transmitting xFlow information to the flow collectors 20 such that the final rate R_{L} of the xFlow information input to the flow collectors 20 becomes the set rates R_{C} of the flow collectors 20.

For example, it is assumed that the set rate R_{C} of the flow collectors 20A is 1/100 and the set rate R_{C} of the flow collectors 20B is 1/10.

In this case, when R_{I}≤R_{C}, the transmission control device 10 transmits the xFlow information of the xFlow packet received from the network device 1 to the flow collectors 20 at a rate of 1/1. On the other hand, when R_{I}>R_{C}, the transmission control device 10 transmits the xFlow information to the flow collectors 20 at a rate for realizing R_{C}=R_{L}.

(2) The method of using absolute rates has an advantage that rates of the xFlow information input to the flow collectors 20 are more easily seen compared with (1) the method of using relative rates.

(3) The Method of Limiting Output Rates to Flow Collectors

Referring back to FIG. 4, (3) the method of limiting output rates to flow collectors is explained. This method is a method of limiting rates (output rates) at the time when the transmission control device 10 transmits xFlow information to the flow collectors 20.

That is, the transmission control device 10 limits output rates to the flow collectors 20 when the output rates of xFlow information to the flow collectors 20 is larger than set values set for the flow collectors 20 irrespective of a value of R_{I} described above.

For example, it is assumed that a set value (a set flow amount F) of the flow collectors 20A is 1000 flow/sec, a set value (a set flow amount F) of the flow collector 20B is 10000 flow/sec, and a flow amount of an xFlow packet received by the transmission control device 10 from the network device 1 is 5000 flow/sec.

In this case, the flow amount (5000 flow/sec) of the xFlow packet received by the transmission control device 10 from the network device 1 is larger than the set value (1000 flow/sec) of the flow collectors 20A. Accordingly, the transmission control device 10 limits an output rate to the flow collectors 20A such that a flow amount of xFlow information to the flow collectors 20A decreases to less than 1000 flow/sec. On the other hand, the xFlow packet received from the network device 1 is not larger than the set value (10000 flow/sec) of the flow collector 20B. Accordingly, the transmission control device 10 does not limit an output rate to the flow collector 20B.

The method explained above has an advantage that it is possible to prevent an upper limit of processing performance of the flow collectors 20 from being exceeded irrespective of the flow amount of the xFlow packet received by the transmission control device 10.

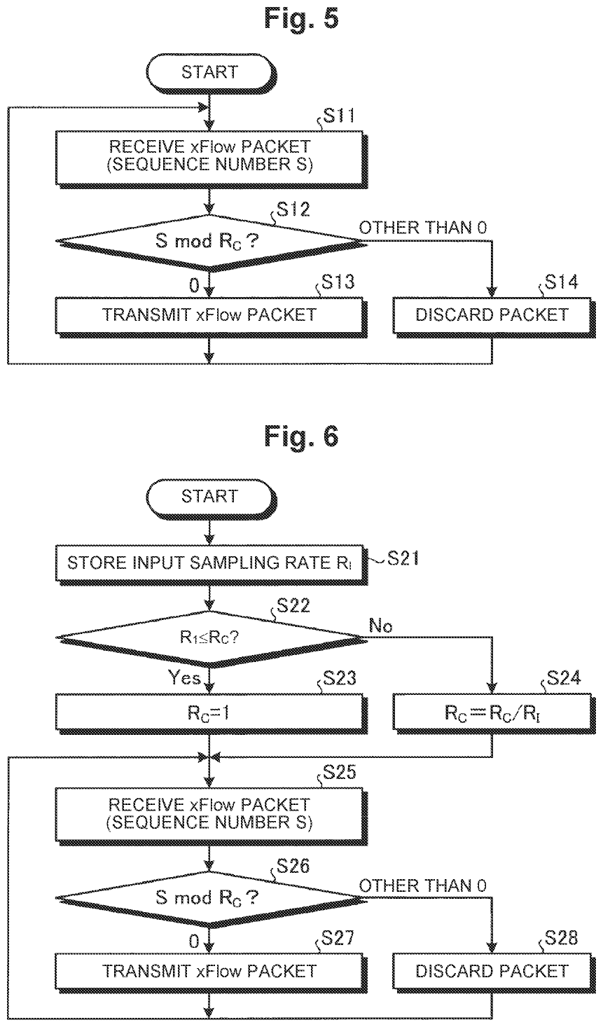

Subsequently, an example of a processing procedure in (1) the method of using relative rates is explained with reference to FIG. 5. Note that an example is explained in which xFlow information transmitted to the flow collectors 20 by the transmission processing unit 134 is an xFlow packet itself.

First, when the receiving unit 130 of the transmission control device 10 receives an xFlow packet from the network device 1 (S11), the transmission processing unit 134 calculates S mod R_{C} (S12). Note that S described above is a sequence number of the xFlow packet received in S11. R_{C} described above is the inverse of a rate set in the flow collector 20 at a transmission destination of the xFlow packet.

If a calculation result in S12 is 0 (“0” in S12), the transmission processing unit 134 transmits the xFlow packet received in S11 to the flow collector 20 (S13). The processing returns to S11. On the other hand, if the calculation result in S12 is other than 0 (“other than 0” in S12), the transmission processing unit 134 discards the xFlow packet received in S11 (S14). The processing returns to S11.

Subsequently, an example of a processing procedure in (2) the method of using absolute rates is explained with reference to FIG. 6.

First, the transmission control device 10 stores an input sampling rate R_{I} (the rate R_{I} described above) (S21). For example, when receiving the rate R_{I} from the network device 1, the receiving unit 130 of the transmission control device 10 stores the rate R_{I} in the storing unit 12.

Subsequently, the transmission processing unit 134 determines whether R_{I}≤R_{C} (S22) and, if R_{I}≤R_{C} (Yes in S22), sets R_{C} to 1 (S23). The processing proceeds to S25. On the other hand, if not R_{I}≤R_{C} (No in S22), the transmission processing unit 134 sets the rate R_{C} to R_{C}/R_{I} (S24). The processing proceeds to S25.

For example, when R_{C} is 1/100 and R_{I} is 1/10, the transmission processing unit 134 sets the rate R_{C} in transmitting an xFlow packet to the flow collectors 20 to 1/10. Consequently, a rate of an xFlow packet input to the flow collectors 20 to an xFlow packet received by the network device 1 can be set to 1/100.

Since processing in S25 to S28 in FIG. 6 is the same as the processing in S11 to S14 in FIG. 5, explanation about the processing is omitted.

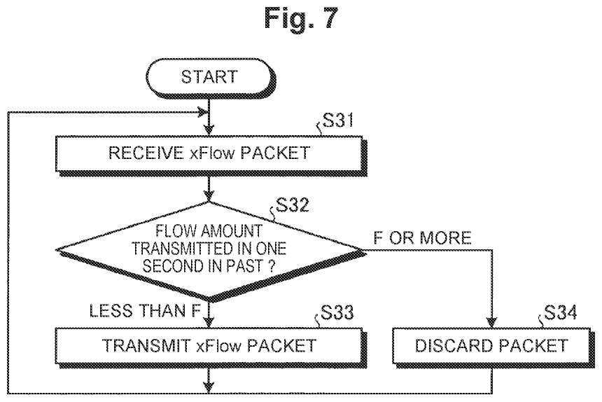

Subsequently, an example of a processing procedure in (3) the method of limiting output rates to flow collectors is explained with reference to FIG. 7.

First, when the receiving unit 130 of the transmission control device 10 receives an xFlow packet from the network device 1 (S31), the transmission processing unit 134 checks a flow amount of an xFlow packet transmitted to the flow collectors 20 in one second in the past (S32). If the checked flow amount of the xFlow packet is less than F (a set flow amount F of the flow collectors 20) (“less than F” in S32), the transmission processing unit 134 transmits the xFlow packet received in S31 to the network device 1 (S33). The processing returns to S31. On the other hand, if the flow amount of the xFlow packet transmitted to the flow collectors 20 in one second in the past is F (the set flow amount F of the flow collectors 20) or more (“F or more” in S32), the transmission processing unit 134 discards the xFlow packet received in S31 (S34). The processing returns to S31.

### Example of Selection of a Flow Collector

As explained above, when there is a plurality of flow collectors 20 having the same functions as transmission destinations of xFlow information from the transmission control device 10, any one flow collector 20 is selected out of these flow collectors 20.

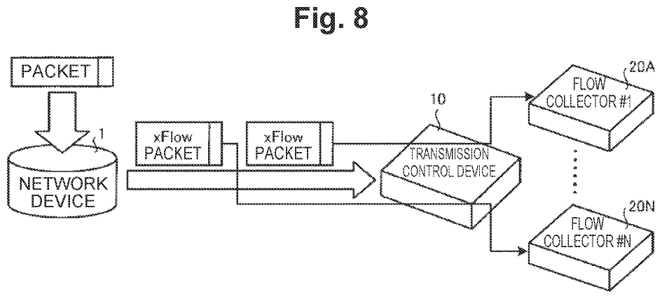

It is assumed that, for example, as shown in FIG. 8, there are a flow collector 20A (a flow collector #1) to a flow collector 20N (a flow collector #N) as the flow collectors 20 to be transmission destinations of xFlow information from the transmission control device 10. Note that it is assumed that the flow collector 20A (the flow collector #1) to the flow collector 20N (the flow collector #N) respectively include the same functions.

For example, when receiving an xFlow packet from the network device 1, the transmission control device 10 selects, based on header information of the xFlow packet, the flow collector 20 to be a transmission destination of xFlow information of the xFlow packet.

As a selection method for the flow collector 20 to be the transmission destination of the xFlow information, for example, (1) a method of using a rearrangement hash and (2) a method of using an own address hash are conceivable.

(1) The method of using a rearrangement hut is performed, for example, as explained below.

The transmission control device 10 rearranges, in ascending order, combinations of transmission source addresses and transmission destination addresses of xFlow packets received from the network device 1, calculates a hash value using the transmission source addresses and the transmission destination addresses as keys, and selects the flow collector 20 corresponding to the calculated hash value. The transmission control device 10 transmits xFlow information of the xFlow packets having the transmission source addresses and the transmission destination addresses to the selected flow collector 20.

In this way, among a group of the received xFlow packets, xFlow information concerning xFlow packets (for example, an xFlow packet of A→B and an xFlow packet of B→A), transmission source addresses and transmission destination addresses of which are the same, is transmitted to the same flow collector 20. Consequently, the flow collector 20 can analyze bidirectional communication (for example, communication of A→B and communication of B→A).

(2) The method of using an own address hash is performed, for example, as explained below.

First, the transmission control device 10 determines own addresses in advance. The number of own addresses may be one or may be plural. The transmission control device 10 extracts, referring to header information of a group of xFlow packets received from the network device 1, xFlow packets in which the own addresses are set in transmission source addresses or transmission destination addresses. The transmission control device 10 calculates a hash value about the extracted xFlow packets using the own addresses as keys and transmits xFlow information of the xFlow packets to the collector 20 corresponding to the calculated hash value.

In this way, among the received group of xFlow packets, the xFlow information of the xFlow packets, the transmission source addresses or the transmission destination addresses of which are predetermined addresses (the own addresses), is transmitted to the same flow collector 20. Consequently, for example, all communications, transmission source addresses or transmission destination addresses of which are the predetermined addresses, can be transmitted to the same flow collectors 20. As a result, the flow collector 20 can analyze communications having the predetermined addresses as transmission sources or transmission destinations.

Note that, as a method of distinguishing the own addresses, for example, a method of preparing a list of own addresses in the transmission control device 10 and distinguishing the own addresses based on the list is conceivable.

When the network device 1 transmits an xFlow packet to the transmission control device 10, the network device 1 may add, to the xFlow packet, identification information indicating whether the xFlow packet is a packet coming from an outgoing direction viewed from the network device 1 or a packet coming from an incoming direction and transmit the xFlow packet. In this case, if the identification information indicating the outgoing direction is added to the xFlow packet received from the network device 1, the transmission control device 10 determines that a transmission source of the xFlow packet is an own address. If the identification information indicating the incoming direction is added to the xFlow packet, the transmission control device 10 determines that a transmission destination of the xFlow packet is an own address.

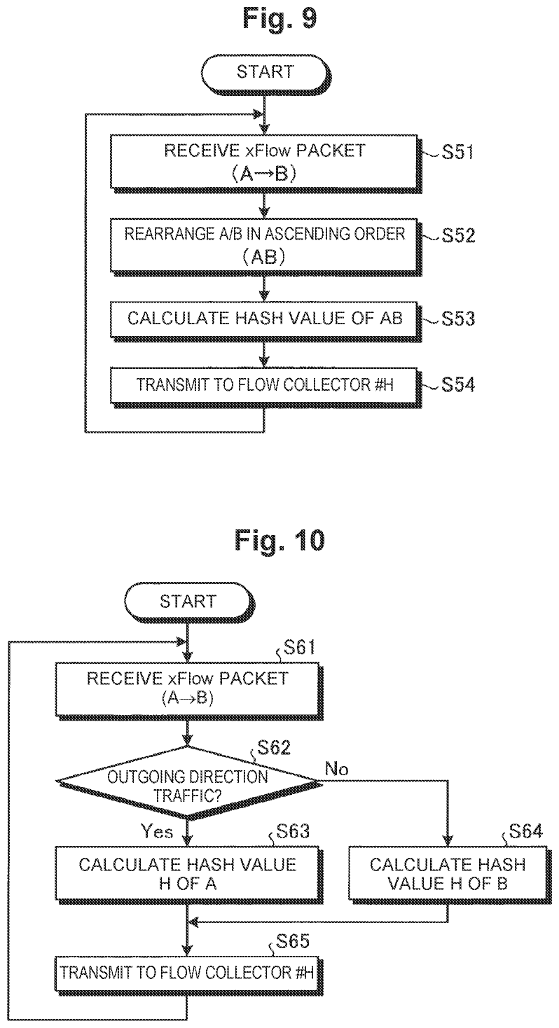

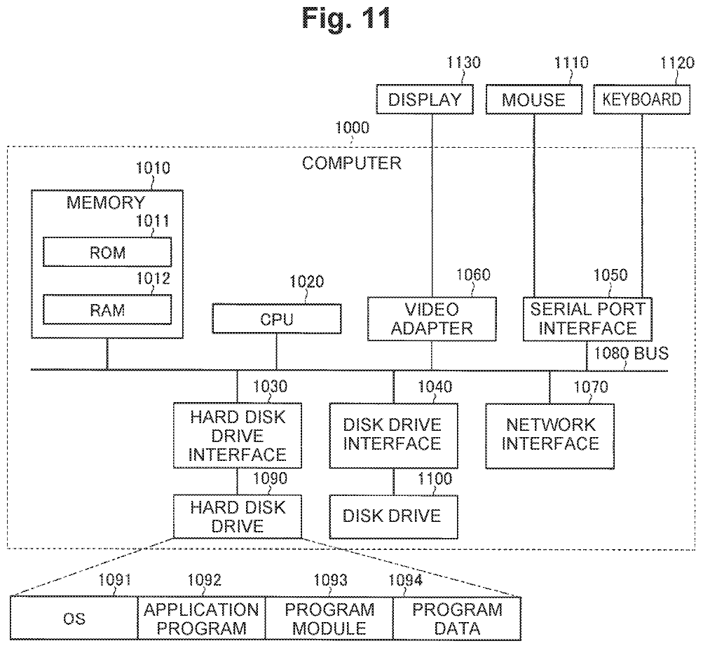

Subsequently, an example of a processing procedure of (1) the method of using a rearrangement hash is explained with reference to FIG. 9. Note that, in FIG. 9 and FIG. 10, “A” indicates a transmission source address of an xFlow packet and “B” indicates a transmission destination address of the xFlow packet.

First, the receiving unit 130 of the transmission control device 10 receives an xFlow packet (A→B) from the network device 1 (S51). Subsequently, the transmission-destination selecting unit 133 rearranges, in ascending order, A or B of the received xFlow packets as a key (S52: rearrange A/B in ascending order). Thereafter, the transmission-destination selecting unit 133 calculates a hash value H of AB (S53). The transmission-destination selecting unit 133 selects a flow collector #H corresponding to the hash value H calculated by the transmission-destination selecting unit 133 as a transmission destination of xFlow information of the xFlow packet. The transmission processing unit 134 transmits the xFlow information of the xFlow packet to the flow collector #H (S54).

Subsequently, an example of a processing procedure of (2) the method of using an own address hash is explained with reference to FIG. 10.

First, the receiving unit 130 of the transmission control device 10 receives an xFlow packet (A→B) from the network device 1 (S61). Subsequently, the transmission-destination selecting unit 133 determines whether the received xFlow packet is traffic in an outgoing direction (S62).

When determining in S62 that the received xFlow packet is the traffic in the outgoing direction (Yes in S62), the transmission-destination selecting unit 133 calculates the hash value H of A (S63). Thereafter, the processing proceeds to S65. On the other hand, when the transmission-destination selecting unit 133 determines in S62 that the received xFlow packet is not the traffic in the outgoing direction (No in S62), the transmission-destination selecting unit 133 calculates the hash value H of B (S64). Thereafter, the transmission-destination selecting unit 133 selects, as a transmission destination of xFlow information of the xFlow packet, the flow collector #H corresponding to the calculated hash value H calculated by the transmission-destination selecting unit 133. The transmission processing unit 134 transmits the xFlow information of the xFlow packet to the flow collector #H (S65).

In this way, when there is a plurality of flow collectors 20 having the same functions in the flow collectors 20 at transmission destinations of the xFlow information, about xFlow information of xFlow packets, at least one of transmission sources and transmission destinations of which are the same, the transmission control device 10 can transmit the xFlow information to the same flow collector 20.

[Program]

A program for realizing the functions of the transmission control device 10 explained in the embodiment above can be realized by being installed in a desired information processing device(computer). For example, it is possible to cause the information processing device to function as the transmission control device 10 by causing the information processing device to execute the program provided as package software or online software. A desktop or notebook personal computer, a rack-mounted server computer, and the like are included in the information processing device referred to herein. Besides, a mobile communication terminal such as a smartphone, a cellular phone, or a PHS (Personal Handyphone System), a PDA (Personal Digital Assistants), and the like are included in a category of the information processing device. The transmission control device 10 may be implemented in a cloud server.

An example of a computer that executes the program (a transmission control program) is explained with reference to FIG. 12. As shown in FIG. 12, a computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM (Random Access Memory) 1012. The ROM 1011 stores a boot program such as a BIOS (Basic Input Output System). The hard disk drive interface 1030 is connected to a hard disk drive 1090. The disk drive interface 1040 is connected to a disk drive 1100. A detachable storage medium such as a magnetic disk or an optical disk is inserted into the disk drive 1100. For example, a mouse 1110 and a keyboard 1120 are connected to the serial port interface 1050. For example, a display 1130 is connected to the video adapter 1060.

As shown in FIG. 12, the hard disk drive 1090 stores, for example, an OS 1091, an application program 1092, a program module 1093, and program data 1094. The various data and the information explained in the embodiment above are stored in, for example, the hard disk drive 1090 and the memory 1010.

The CPU 1020 reads out the program module 1093 and the program data 1094 stored in the hard disk drive 1090 to the RAM 1012 according to necessity and executes the procedures explained above.

Note that the program module 1093 and the program data 1094 relating to the transmission control program explained above are not limited to be stored in the hard disk drive 1090 and may be, for example, stored in a detachable storage medium and read out by the CPU 1020 via the disk drive 1100 or the like. Alternatively, the program module 1093 and the program data 1094 relating to the program explained above may be stored in another computer connected via a network such as a LAN or a WAN (Wide Area Network) and read out by the CPU 1020 via the network interface 1070.

### REFERENCE SIGNS LIST

1 Network device
10 Transmission control device
20, 20A, 20B Flow collector
12 Storing unit
13 Control unit
130 Receiving unit
131 Generating unit
132 Rate determining unit
133 Transmission-destination selecting unit
134 Transmission processing unit

1. A transmission control device comprising a memory and a processor configured to:
receive packets of a flow from a network device;
store information concerning one or more flow collectors to be transmission destinations of information concerning the flow of the received packets;
determine, according to processing abilities of the flow collectors, rates in transmitting the information concerning the flow to the flow collectors;
select, based on header information of the received packets, the flow collector to be a transmission destination of the information concerning the flow of the packets; and
transmit, at the rate determined for each of the flow collectors, the information concerning the flow to the flow collector.

2. The transmission control device according to claim 1, wherein, when there is a plurality of flow collectors having same functions in the flow collectors at the transmission destinations of the information concerning the flow, about information concerning a flow of packets, at least one of transmission sources and transmission destinations of which are common, among the received packets, the processor of the transmission control device selects, as the transmission destination, any one flow collector among the flow collectors having the same functions.

3. The transmission control device according to claim 1, wherein the processor of the transmission control device sets the rate in transmitting the information concerning the flow to the flow collector larger as processing ability of the flow collector is higher.

4. A transmission control method comprising:
receiving packets of a flow from a network device;
determining, according to processing abilities of flow collectors to be transmission destinations of information concerning the flow of the received packets, rates in transmitting the information concerning the flow to the flow collectors;
selecting, based on header information of the received packets, the flow collector to be a transmission destination of the information concerning the flow of the packets; and
transmitting, at the rate determined for each of the flow collectors, the information concerning the flow to the flow collector.

5. A non-transitory, computer-readable medium storing a transmission control program for causing a computer to execute:
receiving packets of a flow from a network device;
determining, for each of flow collectors to be transmission destinations of information concerning the flow of the received packets, rates in transmitting the information concerning the flow to the flow collectors;
selecting, based on header information of the received packets, the flow collector to be a transmission destination of the information concerning the flow of the packets; and
transmitting, at the rate determined for each of the flow collectors, the information concerning the flow to the flow collector.
